(19) United States
(12) Patent Application Publication
(10) Pub. No.: US 2026/0006520 A1
(43) Pub. Date: Jan. 1, 2026

(54) ENHANCED HIGH FREQUENCY CELLULAR MULTIPLE RECEIVER CHANNEL METHODS

(71) Applicant: ROCKWELL COLLINS, INC., Cedar Rapids, IA (US)

(72) Inventors: Mark JORGENSON, Kanata (CA); James STEVENS, Lucas, TX (US)

(73) Assignee: ROCKWELL COLLINS, INC., Cedar Rapids, IA (US)

(21) Appl. No.: 18/755,927

(22) Filed: Jun. 27, 2024

(51) Int. Cl. H04W 36/30; H04W 36/38

(52) U.S. Cl. CPC H04W 36/304; H04W 36/38

(57) ABSTRACT

A high frequency (HF) cellular system includes base stations and mobile radio stations communicating through calls and links. The base stations include multiple receive channels to enable better management of calls within the HF cellular system. A signal from a mobile radio station within the HF cellular system is received by a first receiver of a first base station. The first base station performs an action related to the signal received from the mobile radio station using the first receiver. While the first receiver is occupied, another signal within the HF cellular system is received by a second receiver of the first base station. The first base station performs an action related to the other signal received by the second receiver.

### FIELD OF THE INVENTION

The subject matter disclosed herein relates to an enhanced high frequency (HF) cellular methods to manage calls between base stations and mobile radio stations.

### BACKGROUND OF THE INVENTION

HF cellular stations enable fixed site HF stations configured as a network to use the station with the best connectivity to a particular mobile radio station to link with that station. When the mobile stations call into any address in the network, the stations in the network that hear the call coordinate, so that only the transmitter of the base station that has the best link to the mobile radio station responds. The transmitter and a paired receiver at the base station is used to form the link. Mobile and ground stations retain history on which channels offer the best quality. This quality, however, may change over time or under different conditions.

Thus, it may be appreciated that a need exists to better manage calls coming from mobile radio stations to base stations in a network under changing conditions in the network.

### SUMMARY OF THE INVENTION

The present disclosure is directed, in some embodiments, to a method for managing resources in a high frequency (HF) cellular system. The method includes receiving a first signal from a first mobile radio station at a first base station having a transmitter and a plurality of receivers in the HF cellular system. The method also includes performing an action related to the first signal using a first receiver of the plurality of receivers at the first base station. The method also includes receiving a second signal from the HF cellular system at a second receiver of the first base station while the first base station is performing the action related to the first signal. The method also includes performing an action related to the second signal using the second receiver at the first base station while the first receiver is occupied with the first signal.

In yet another embodiment, the present disclosure is directed to a method for managing resources in a high frequency (HF) cellular system. The method includes enabling a controller to receive a signal or information about the signal from at least one base station of a plurality of base stations communicatively coupled to the controller. Each of the plurality of base stations includes a transmitter and a plurality of receivers. The method also includes evaluating the signal or the information about the signal from the at least one base station at the controller. The method also includes sending an instruction from the controller to the at least one base station of the plurality of base stations. The method also includes configuring at least one receiver of the plurality of receivers at the at least one base station based on the evaluated signal or the information about the signal.

In yet another embodiment, the present disclosure is directed to a high frequency (HF) cellular system is disclosed. The HF cellular system includes a plurality of base stations communicatively coupled to each other. A first base station of the plurality of base stations includes a transmitter and a plurality of receivers. The HF cellular system also includes a plurality of mobile radio stations configured to transmit signals with the HF cellular system. A first receiver of the plurality of receivers at the first base station receives a first signal from a first mobile radio station and the first base station performs a first action related to the first signal using the first receiver. A second receiver of the plurality of receivers at the first base station receives a second signal from the HF cellular system while the first base station is performing the first action related to the first signal and the first base station performs a second action related to the second signal using the second receiver while the first receiver is occupied with the first signal.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, numerous variations are possible. For instance, structural elements and process steps may be rearranged, combined, distributed, eliminated, or otherwise changed, while remaining with the scope of the disclosed embodiments.

### BRIEF DESCRIPTION OF FIGURES

The features of the disclosure believed to be novel and the elements characteristic of the invention are set forth with particularity in the appended claims. The figures are for illustration purposes only and are not drawn to scale. The disclosure itself, however, both as to organization and method of operation, can best be understood by reference to the description of the preferred embodiment(s) which follows, taken in conjunction with the accompanying drawings in which:

FIG. 1 illustrates a block diagram of a high frequency (HF) cellular system according to the disclosed embodiments.

FIG. 2 illustrates a schematic diagram of a base station according to the disclosed embodiments.

FIG. 3 illustrates a block diagram of the base stations having a transmitter and multiple receivers according to the disclosed embodiments.

FIG. 4 illustrates a flowchart for handing off a link during operations in the HF cellular system according to the disclosed embodiments.

FIG. 5 illustrates a flowchart for handing off a call within the HF cellular system to due to degrading of the link between the base station and the mobile radio station according to the disclosed embodiments.

FIG. 6 illustrates a flowchart for managing resources for handling calls within the HF cellular system according to the disclosed embodiments.

FIG. 7 illustrates a flowchart for further managing resources in the HF cellular system using a controller according to the disclosed embodiments.

FIG. 8 illustrates a flowchart for managing resources in the HF cellular system by the controller after receiving a linking call according to the disclosed embodiments.

FIG. 9 illustrates a flowchart for managing resources between different base stations in the HF system by the controller according to the disclosed embodiments.

FIG. 10 illustrates a flowchart for managing resources in the HF cellular system to monitor links according to the disclosed embodiments.

### DETAILED DESCRIPTION OF THE INVENTION

The embodiments of the present disclosure can comprise, consist of, and consist essentially of the features and/or steps described herein, as well as any of the additional or optional ingredients, components, steps, or limitations described herein or would otherwise be appreciated by one of skill in the art.

As used herein, a letter following a reference numeral is intended to reference an embodiment of the feature or element that may be similar, but not necessarily identical, to a previously described element or feature bearing the same reference numeral, such as 1, 1a, or 1b. Such shorthand notations are used for purposes of convenience only, and should not be construed to limit the inventive concepts disclosed herein in any way unless expressly stated to the contrary.

Moreover, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of embodiments of the instant disclosed concepts. This is done merely for convenience and to give a general sense of the disclosed concepts, and “a” and “an” are intended to include one or at least one and the singular also includes plural unless it is obvious that it is meant otherwise. It will be further understood that the terms “comprises” or “comprising,” when used in this specification, specify the presence of stated features, integers, steps, operations, elements, or components, but do not preclude the presence or addition of one or more other features, integers, steps, operations, elements, components, and/or groups thereof.

As used herein, any reference to “one embodiment,” “alternative embodiments,” or “some embodiments” means that particular element, feature, structure, or characteristic described in connection with the embodiment is included in at least one embodiment of the inventive concepts disclosed herein. The appearances of the phrase “in some embodiments” in various places in the specification are not necessarily all referring to the same embodiment, and embodiments of the disclosed concepts disclosed may include one or more of the features expressly described or inherently present herein, or any combination or sub-combination of two or more such features, along with any other features that may not necessarily be expressly described or inherently present in the instant disclosure.

The disclosed embodiments may be described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts, or combinations of special purpose hardware and computer instructions.

Inventive concepts may be implemented as a computer process, a computing system or as an article of manufacture such as a computer program product of computer readable media. The computer program product may be a computer storage medium readable by a computer system and encoding computer program instructions for executing a computer process. When accessed, the instructions cause a processor to enable other components to perform the functions disclosed below.

The intent of the HF cellular system is to enable fixed site HF stations configured as a network to use the base station with the best connectivity to any of the mobile radio stations to link with that mobile radio station. For example, the base station with the best link to the mobile radio station may respond. At high frequency, this station often is not the nearest station, so there are significant operational benefits to this approach. In some embodiments, each fixed site in an HF cellular system has a single transmitter and a single receiver, operating as a transceiver even when the system uses separate transmit and receive sites.

According to the disclosed embodiments, the system includes a plurality of base stations. Each base station may include a transmitter and two or more receivers. A controller may be communicatively coupled to the base stations in order to control the management of the receivers at the base stations to respond to calls and other signals efficiently and in an optimal manner. The controller may receive information from each base station and evaluate signals received to manage the resources between the base stations.

Additional receivers may be employed with more than one receiver associated with each transmitter at an HF cellular site. Where the receiver is co-sited with the transmitter, it may be necessary to provide sufficient isolation between the transmit channel and the receive channel to allow good receiver performance on the channels other than the channel on which the transmitter is currently active. Additional receiver channels are likely to be more routinely available as HF radios move to direct sampling architectures that support multiple receiver channels with digital down conversion of frequencies across the HF band. The disclosed embodiments use multiple receivers, whether embodied as distinct devices or as distinct receiver channels within any form of multichannel radio, at HF cellular base stations to enhance performance. These base stations may be fixed, but, alternatively, also may be mobile.

In an HF cellular system, one way that mobile radio stations determine the best frequency to use to contact the network is for the mobile stations to sound each of the channels that are available for use. Sounding may refer to making a transmission for the purposes of allowing evaluation. Fixed sites that hear a sounding transmission remain on that channel long enough to evaluate the link between the mobile radio station and the fixed, or base, station. With a single receiver at each site, this feature impacts the capacity of the network because it prevents a station with only a single receiver from searching for call attempts or other sounds during the interval that it is evaluating a sound.

The impact of this behavior is magnified with systems with single receiver fixed site stations because while sounds are active, all fixed site stations not otherwise occupied will spend a significant amount of time listening to the same active sounding transmissions, thereby reducing the capacity of the network to find new calls. This feature makes it a network issue rather than an individual site issue. With more than one single receiver or receiver channel available, the one or more receivers that are not occupied with evaluating the sounding transmission are available to continue to scan the scan list. A scan list may be a list of frequencies, or channels, assigned to the HF cellular system that are monitored by the base station or base stations. In some embodiments, the scan list has at least two distinct entries.

When a mobile radio station initiates a call into an HF cellular network having a single receiver at each station, stations that are not linked, or occupied with evaluating sounding transmissions, have the opportunity to hear the call and a specific HF cellular station may be chosen to respond to the call based on the reception quality at each of the stations. This process does not allow stations that were unable to receive the call to respond. These stations may have better connectivity to the new caller but because they were not able to receive the initial call, they are not considered as an option for linking with the current link attempt. When one or more base stations have more than one receiver, those base stations can have one receiver occupied, whether in a link, listening to an initial call, or evaluating a sound, and still have one or more receivers available to continue to scan for calls or sounds. This feature may improve the capacity of the HF cellular system by reducing missed calls.

When stations have more than one receiver, a station that is in a call may still listen to a new link attempt from a different mobile radio station. If the station with the best link quality reception of the stations that hear the linking call is currently in a link with a mobile radio station, and if another available station has a good quality link to the mobile radio station already in link, then a hand-off of the active link may be made. Another station may be selected to continue the already active link, while the station that was supporting the link is freed up to answer the caller.

In some embodiments, the best base station to receive signals from multiple mobile radio stations may have more than one receiver that helps in increasing capacity to respond to calls. The controller communicatively connected to the plurality of base stations may control receivers that the base stations to optimize the handling of calls and providing increased quality of managing calls. For example, a base station may establish a link using its transmitter and a first receiver at the base station with a mobile radio station. The controller also may manage a link with another mobile station using a second receiver at the first base station and a transmitter at a second base station. As transmitters can generate high-powered signals, the transmitter at the second base station may reach the mobile radio station even if the mobile radio station may not be able to send an adequate signal to a receiver at the second base station.

As disclosed above, each base station may include a transmitter along with a plurality of receivers. If the station currently in-link is actively transmitting using the transmitter, then a deferred hand-off may be arranged where the stations' assignments change at a pause in the transmission. In either scenario, the coordination of the hand-off is facilitated by the additional receivers and the coordination possible over the HF cellular terrestrial infrastructure.

Hand-offs also may be facilitated for stations that are in-link, but where propagation between the mobile radio station and the active base station degrades. It may be beneficial to change the ground, or base, station assigned to the link. Any station not in-link or in-link but with at least one available receiver may determine their reception quality for the mobile end of the active links. Those stations with good quality links may be alternative options if a hand-off becomes necessary. If every station has at least one additional channel, then the HF cellular system may work towards utilizing resources to optimize all active links, as opposed to optimizing each link with the resources currently available as the link is initiated.

Where additional receivers are available, their operation may be controlled by the HF cellular system to provide better coverage of the channels in the scan list. Events such as linking calls that tie up a receiver from each station may result in missed calls when the system is busy. All stations hearing a linking call remain in the channel until they are released by the HF cellular system when a specific station is chosen to make the link.

When stations are released, they return to their normal scanning of the scan list. For asynchronous scanning, this feature results in all stations released at the same time effectively synchronized in their scan of the scan list. The disclosed system could select the channel for each station to begin scanning following a linking call to minimize the possibility of missing a subsequent linking call. It also may be possible for the HF cellular system to actively manage the scanning of receivers in the system to maximize capacity or minimize the likelihood of missing of a call.

Additional receivers also allow the potential for receive diversity. Where a link is marginal, or where the receiver resources are not otherwise required, more than one receive site may be tasked by the HF cellular system to assign a receiver to receive signals from a particular mobile radio. The HF cellular system would optimize the use of the available receive resources across the network to service mobile radio demands. Any of a plurality of receive diversity approaches may be applied to using multiple independent receptions to reduce errors or outages on the link from the mobile to the HF cellular network. For example, the receivers could independently receive the transmission and share the detected data or the signal received at each receiver could be shared, thereby allowing detection of the data from the two signals by a diversity combiner that takes full advantage of the available diversity gain.

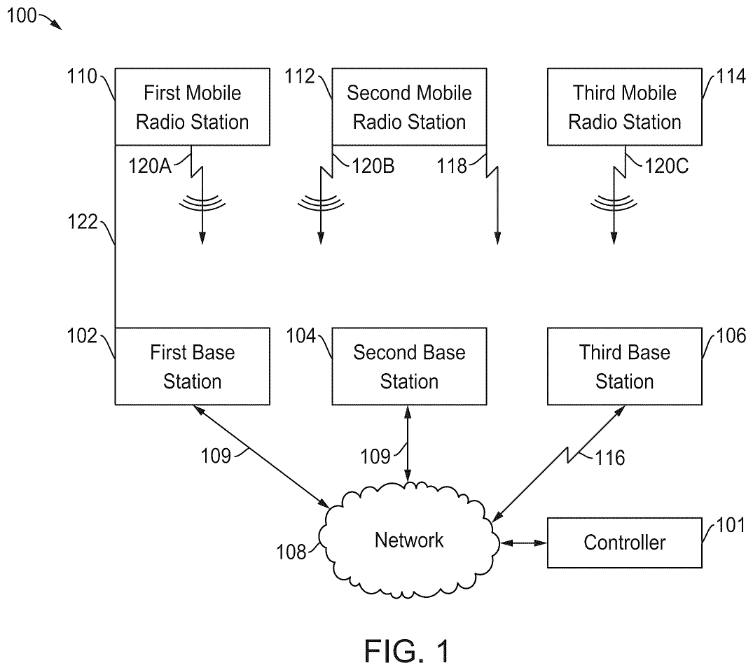

FIG. 1 depicts a block diagram of a high frequency (HF) cellular system 100 according to the disclosed embodiments. HF cellular system 100 includes first base station 102, second base station 104, and third base station 106. System 100 may include additional base stations that are not disclosed here for brevity. System 100 also includes first mobile radio station 110, second mobile radio station 112, and third mobile radio station 114. Again, additional mobile radio stations may be used within system 100, but not shown here for brevity.

Controller 101 also is included in HF cellular system 100. Controller 101 is coupled to first base station 102, second base station 104, and third base station 106. Controller 101 manages HF cellular operations of the base stations as well as managing calls and operations within the system. Controller 101 may communicate with the base stations through network 108, or, alternatively, it may be connected directly with one or more of the base stations. In some embodiments, controller 101 may be collocated with one of the base stations, such as base station 102. In further embodiments, controller 101 may implement the functions and features of computation component 201, disclosed below.

First base station 102 and second base station 104 may be connected through network 108. In some embodiments, network 108 may include fiber connections 109 between stations 102 and 104 to allow the base stations to exchange information and data. First base station 102 and second base station 104 may be fixed stations within system 100. Third base station 106, however, may be a mobile station and connected within network 108 using connection 116. Connection 116 may be a combination of fiber or other terrestrial bearer near to the mobile station and a wireless connection from there to the station.

Mobile stations 110, 112, and 114 make calls in system 100 using base stations 102, 104, and 106. When a mobile radio station calls to an address in system 100, base stations 102, 104, and 106 coordinate with each other to determine which base station takes the call. The base station with the best link to the mobile radio station responds. For example, second mobile radio station 112 may make call 118. This call goes to each of the three base stations, though not explicitly shown in FIG. 1. The base stations may determine that second base station 104 provides the best performance in taking call 118 so that a link is established with second mobile radio station 112.

Mobile stations 110, 112, and 114 may initiate sounding transmissions, shown as 120A, 120B, and 120C, respectively. It may be appreciated that sounding transmissions 120A, 120B, and 120C normally are not transmitted at the same time. As disclosed above, sounding transmissions allow for evaluating the performance of each channel available for use by the mobile stations within system 100. All HF cellular base stations, such as first base station 102, second base station 104, and third base station 106, have the opportunity to receive, or hear, sounding transmissions 120A, 120B, and 120C and remain on the channel long enough to evaluate a link between the mobile radio station and the respective base station during the time when each of the sounding transmissions is active.

For example, first base station 102 may receive sounding transmission 120A and evaluate the performance or quality of a link with first mobile radio station 110. First base station 102 may store the evaluation. It then may receive sounding transmission 120B and evaluate the performance or quality of a link with second mobile radio station 112. First base station 102 also stores this evaluation. It then may receive sounding transmission 120C and perform the evaluation for a link to third mobile radio station 114. This evaluation also is stored. In some embodiments, these evaluations may be shared with second base station 104, which also shares the results of its evaluations based upon receiving sounding transmissions 120A, 120B, and 120C.

The evaluation may measure the signal strengths of sounding transmissions 120A, 120B, and 120C. Each channel at a base station may be evaluated. For example, first base station 102 may define a table or scan list that includes all the channel numbers associated with the frequencies to be measured. First base station 102 may have a scanning order, such as from lowest channel number to highest channel number. This process may be synchronous or asynchronous. For a synchronous operation, the time at which transmissions occur on specific channels is specified. This feature allows receivers to look at the channel at the correct time to receive a signal. For asynchronous operation, any channel may be accessed at any time. The initial transmission, whether a call or sounding transmission, needs to be long enough so that the intended receiver has time to go through the entire scan list and be guaranteed to hear the transmission as long as that channel is propagating.

When a mobile radio station makes a call into HF cellular system 100, stations that are not linked have the opportunity to hear the call and may be chosen to respond accordingly based on reception quality. For example, second mobile radio station 112 may initiate call 118. Call 118 is treated as an incoming call by first base station 102, second base station 104, and third base station 106. The quality of the received call at each base station is determined to decide which base station will respond. In this instance, second base station 104 may have the best reception quality for establishing a link to second mobile radio station 112 to accept call 118.

Controller 101 may determine which base station will respond based on the received quality of the call at each base station. Alternatively, one of the base stations may make the determination. These embodiments also may use link quality analysis (LQA) tables maintained for indicating the reachability of the mobile radio stations. The historical LQA data may be taken into account when deciding which base station will respond to the calls received within system 100 along with the quality of the received signals at the base stations.

Alternatively, first base station 102 may have the best performance quality to receive call 118. Yet, first base station 102 currently has a link 122. Under known systems, first base station 102 would not take call 118 as it is busy with link 122. According to the disclosed embodiments, however, first base station 102 may hand off link 122 to another base station and accept call 118. If first base station 102 is actively transmitting on link 122, then a deferred hand-off may be arranged. These features are disclosed in greater detail below.

The disclosed embodiments also may perform hand-offs for base stations that are in-link but where performance between the mobile radio station and the base station degrades to the point that it would be better to change to a base station having better performance parameters. For example, link 122 between first base station 102 and first mobile radio station 110 may degrade, for example, due to movement of the first mobile radio station or the propagation changing for the signal of link 122. The disclosed embodiments may determine that second base station 104 has at least one receiver open that provides improved reception quality to establish link 122 with first mobile radio station 110. In other words, second base station 104 has better reception from second mobile radio station 112 than first base station 102. The disclosed embodiments then would hand off link 122 to second base station 104.

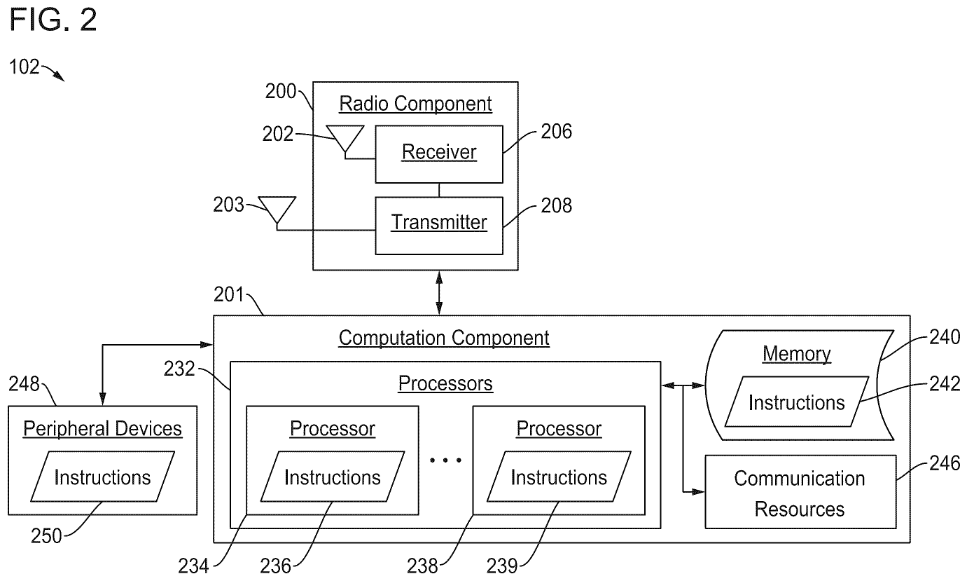

FIG. 2 depicts a schematic diagram of a base station according to the disclosed embodiments. FIG. 2 also may depict a schematic diagram of mobile radio stations 110, 112, and 114. A potential difference between the base stations and the mobile radio stations of the disclosed embodiments is that the base stations are communicatively coupled through infrastructure, such as network 108, while mobile radio stations rely on HF links to reach into the network. FIG. 2 refers to first base station 102 but the disclosure also may pertain to second base station 104 or third base station 106. Each station may include at least one radio component 200 having the features disclosed below. First base station 102 may include computation component 201, which also acts as part of the network infrastructure for HF cellular system 100. Stations 104, 106, 110, 112, and 114 also may include one or more features of computation component 201.

It may be appreciated that first base station 102, along with base stations 104 and 106, are communicatively coupled to controller 101, which may perform the function of evaluating signal quality of receptions and determines which base station will respond to calls. Controller 101 also may be used to embody other features of the disclosed embodiments, such as coordinating hand-offs or controlling receive scan timings at individual receivers. First base station 102 also may be operated in a split site mode where transmit and receive components are separated, which is not possible for mobile radio stations.

Radio component 200 may send and receive high frequency (HF) signals within HF cellular system 100. An HF signal refers to a wireless electromagnetic signal used as a form of communication or to transmit data. The HF signal may be a form of electromagnetic radiation with identified radio frequencies with different bands. Frequency refers to the rate of oscillation of the radio waves of the HF signals. Each band has different capabilities. For example, the frequency range of the HF signals may be from 3 to 30 MHz, but also includes frequencies as low as 1.5 MHz or as high as 60 MHz. It may be appreciated that the disclosed embodiments are not limited to these frequency ranges.

Radio component 200 includes antenna 202, receiver 206, and transmitter 208. Antenna 202 may transmit and receive HF signals within HF cellular system 100. Antenna 202 converts electrical signals into electromagnetic waves. Antenna 202 may be one of a variety of types of antennas, such as dipole, monopole, and Yagi-Uda antennas. Antenna 202 may radiate or receive the electrical signals over a certain range of frequencies.

One or more receivers may be coupled to antenna 202. Transmitter 208 may be coupled to a separate antenna 203, which is similar in function and design to antenna 202. In some embodiments, receiver 206 and transmitter 208 may be embodied in a transceiver for radio component 200 such that these components are connected to a single antenna for transmit and receive.

Referring to receiver 206, this part of radio component 200 manages the reception of HF signals within system 100 according to a communication protocol. First base station 102 may include more than one receiver 206 such that different signals may be detected and received at radio component 200. Receiver 206 also may convert the received signals into data to be provided to computation component 201.

Transmitter 208 also is part of radio component 200. Transmitter 208 may receive an input signal. The input signal may be a voltage input to control the oscillation frequency of transmitter 208. Transmitter 208 may include an oscillator circuit that generates a periodic waveform, such as a sine wave. The amplitude and frequency of oscillation may be controlled by applying a control or tuning voltage. The generated HF signal transmits from radio component 200 using antenna 203.

These features of radio component 200 may differ depending on the application of first base station 102. Further, they may differ for implementation within stations 104, 106, 110, 112, and 114. Depending on the functionality desired by first base station 102 and HF cellular system 100, radio component 200 may operate differently than disclosed above. For example, additional filters or amplifiers may be included within receiver 206 or transmitter 208. Further, additional receive channels may be defined such that different receivers 206 may be implemented.

First base station 102 also may include computation component 201. Second base station 104 and third base station 106 also may include a computation component 201. Controller 101 also may include a computation component 201. Computation component 201 may be part of the network infrastructure that manages the access of nodes within HF cellular system 100. Computation component 201 may receive processed signals from one or more receivers 206 or to transmit signals through one or more transmitters 208. Further, computation component 201 may include applications that use signals to derive information within HF cellular system 100.

Computational component 201 may be able to read instructions for a machine-readable or computer-readable medium and perform one or more of the functions disclosed herein. Computational component 201 includes one or more processors 232, one or more memory, or storage, devices 240, and one or more communication resources 246. These features may be communicatively coupled to each other.

Processors 232 may include a processor 234 and a processor 238. The term processor also may refer to a processor core within computational component 201. Processors 232 and 238 may be a central processing unit (CPU), a reduced instruction set computing (RISC) processor, a complex instruction set computing (CISC) processor, a graphics processing unit (GPU), a digital signal processor (DSP) such as a baseband processor, an application-specific integrated circuit (ASIC), a field-programmable gate array (FPGA), a radio-frequency integrated circuit (RFIC), and the like.

Memory devices 240 may include a main memory, disk storage, or any combination thereof. Memory devices 240 may include but are not limited to, any type of volatile, non-volatile, or semi-volatile memory such as dynamic random access memory (DRAM), static random access memory (SRAM), erasable programmable read-only memory (EPROM), electrically erasable programmable read-only memory (EE-PROM), flash memory, solid-state storage, and the like. Peripheral devices 248 also may be memory devices having similar features.

Communication resources 246 may include interconnection or network interface controllers, components, or other suitable devices to communicate with one or more peripheral devices 248. First base station 102 may use radio component 200 for communicating over HF cellular system 100 but communication resources 246 also may be used to interface with components within network 108.

Instructions 236, 239, 242, and 250 may include software, a program, an application, an applet, an app, or other executable code for causing the respective processors to perform the functionality and operations disclosed herein. Instructions 236 may configure processor 234 to execute operations. Instructions 239 may configure processor 238 to execute operations in addition to the operations executed by processor 234. Instructions 236 and 239 may reside, completely or partially, within processors 234 and 238, respectively. These instructions also may reside in memory devices 240 as instructions 242 or in peripheral devices 248 as instructions 250. Instructions 242 and 250 may be transferred to processors 232.

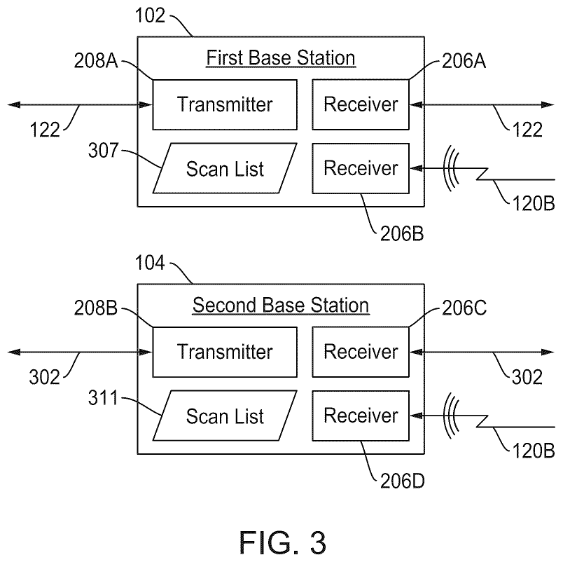

FIG. 3 depicts a block diagram of the base stations having a transmitter and multiple receivers according to the disclosed embodiments. Base stations may include multiple receivers so that they may improve capacity within system 100. This feature provides benefits over a base station having a single receiver. With a single receiver, a base station may not search for calls, such as call 118, from mobile radio stations during the interval in which it is evaluating a sounding transmission, such as sounding transmission 120A, 120B, or 120C, or when it is receiving another initial linking call, or when it is already in link.

Having more than one receiver, the base station may have a receiver that is not occupied with evaluating a sounding transmission or supporting an ongoing link to a mobile radio station. This receiver is available to continue scanning the scan list for calls from the mobile radio stations. For example, first base station 102 may include transmitter 208A and receiver 206A and 206B. The disclosed embodiments include base stations having more than two receivers, such as eight receivers. Two receivers are shown for brevity. Receivers 206A and 206B correspond to receiver 206, as disclosed above. Transmitter 208A corresponds to transmitter 208, as disclosed above. Transmitter 208A and receiver 206A may be in-link with link 122 with first mobile radio station 110. Receiver 206B is able to evaluate sounding transmission 120B from second mobile radio station 112 or sounding transmission 120C from third mobile radio station 114, as well as receive linking calls from these radio stations.

Second base station 104 also includes transmitter 208B and multiple receivers 206C and 206D. Receivers 206C and 206D also correspond to receiver 206. Transmitter 208B also corresponds to transmitter 208. Second base station 104 may use the multiple receivers to perform various operations as well. For example, transmitter 208A and receiver 206C may establish a link 302 with a mobile radio station based on a call received in HF cellular system 100. Receiver 206D may evaluate sounding transmission 120B along with receiver 206B of first base station 304 even though both base stations currently have links with mobile radio stations.

Referring back to first base station 102, with multiple receivers, it may be able to continue to use scan list 307 in scanning for potential calls in HF cellular system 100. Receiver 206A is engaged with link 122 and receiver 206B may evaluate sounding transmissions or receive linking calls from mobile radio stations.

For example, when nothing is happening at first base station 102, it may have a receiver, such as receiver 206A, go through scan list 307, listening to each frequency channel of the scan list in sequence. At some point, receiver 206A may hear a signal and it stops to evaluate that signal. For the duration of the time that it is evaluating that signal, receiver 206A is not available for anything else. If the signal is a linking call, then receiver 206A may be tasked to stay on channel for a link, such as link 122. Otherwise, receiver 206A likely returns to scan following the evaluation of that signal, whether a sounding transmission or an initial linking call.

With regard to second base station 104, this base station also may perform similar operations to first base station 102. In another example, second base station 104 may be unable to scan for new calls using scan list 311 during the interval when receiver 206C is supporting an active link 302 and receiver 206D is evaluating a sounding transmission from a mobile radio station within HF cellular system 100.

In some embodiments, referring back to FIG. 1, second mobile radio station 104 initiates call 118. All base stations that currently have at least one receiver available may listen to call 118. HF cellular system 100 may determine that first base station 102 is best situated to take call 118 but it is currently engaged with link 122. Receiver 206B is able to evaluate performance between first base station 102 and second mobile radio station 112 based on the received signal for call 118. The disclosed embodiments may hand off the active link to free up first base station 102 to answer call 118. Thus, using monitoring of the active link by second base station 104 or LQA data from sounding transmissions, it may be determined that second base station 104 may take over active link 122. Controller 101 of HF cellular system 100 may make this determination. First base station 102 hands off link 122 to second base station 104. First base station 102 is now free and may engage call 118 and set up an active link between it and second mobile radio station 112.

If first base station 102 is transmitting over link 122, then a deferred hand-off may be arranged. The hand-off of link 122 to second base station 104 may occur during a pause in transmission. In any event, the coordination of the hand-off is facilitated by the coordination possible over HF cellular system 100 using controller 101 and the performance information provided by the base stations.

Management of existing links also may occur using the multiple receivers of first base station 102 and second base station 104. Facilitation of hand-offs may occur for a station having an active link so that transmitter 208 is being used yet the multiple receivers 206 may be available. Degradation of the link may require that it be handed off to another base station.

For example, first base station 102 is engaged with active link 122 between first mobile radio station 110. First mobile radio station 110 may move or some other condition may occur to degrade the quality of link 122. This degradation may be brought to the attention of controller 101. It may be better to change the base station assigned to link 122. Controller 101 may task receivers at the base stations to monitor the ongoing link to determine which receiver may work best. Controller 101 receives data from second base station 104 that indicates the reception quality for calls from second mobile radio station 112 is good enough or better than that for first base station 102. If a hand-off becomes necessary, then second base station 104 would be available to take over link 122 from first base station 102.

The disclosed embodiments also may utilize multiple receive channels at base stations to provide better coverage of the channels by HF cellular system 100. Calls that result in links may occupy a receive channel from each base station, which may result in missed calls when system 100 is busy. All stations hearing a linking call may remain on the receive channel until they are released by HF cellular system 100 when a specific station is chosen to make the link. When stations are released, they return to their normal scanning of the scan list. For asynchronous scanning, this situation results in the base stations being released at the same time, thereby effectively synchronizing the scanning of the scan lists between stations.

In some embodiments, HF cellular system 100 may select a receiver channel at each base station for individual receivers to begin scanning following a linking call to minimize the possibility of missing a subsequent linking call. For example, receiver 206A of first base station 102 and receiver 206C of second base station 104 hear call 118. Third base station 106 also has a receive that hears call 118. Receiver 206A, receiver 206C, and the receiver at third base station 106 remain on the receive channel until one of them is selected to receive call 118 and establish a link. For example, second base station 104 and receiver 206C may be selected to receive call 118 and generate link 320. Receiver 206A of first base station 102 and the receiver at third base station 106 are released.

Additional receivers allow for receive diversity. For example, more than one base station may be tasked by HF cellular system 100 to assign a receiver to receive signals from a particular mobile radio station. HF cellular system 100 may optimize the use of the available receive resources across network 108 to take care of calls and demands from a plurality of mobile radio stations. Receiver 206A of first base station 102 and receiver 206C of second base station 104 may be assigned to receive calls from first mobile radio station 110. Using the additional receive channels at the base stations, active monitoring and evaluation of the ongoing link may allow HF cellular system 100 to switch the dedicated receive channels as conditions change.

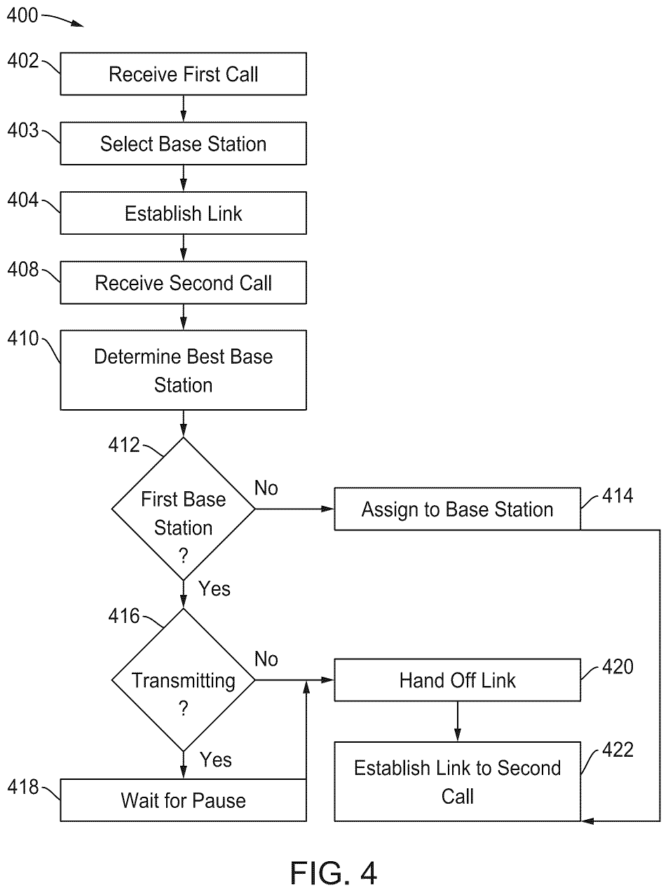

FIG. 4 depicts a flowchart 400 for handing off a link 122 during operations in HF cellular system 100 according to the disclosed embodiments. Flowchart 400 may refer to FIGS. 1-3 for illustrative purposes. Flowchart 400, however, is not limited to the embodiments disclosed by FIGS. 1-3.

Step 402 executes by receiving a first call from first mobile radio station 110 in HF cellular system 100. This call may be a linking call that sends a signal to each base station accessible by first mobile radio station 110. Referring to FIG. 1, these base stations may include first base station 102, second base station 104, and third base station 106.

Step 403 executes by selecting a base station to receive the first call in HF cellular system 100. The base station is selected based on reception quality of the call from first mobile radio station 110. For example, controller 101 of HF cellular system 100 may determine first base station 102 has the best reception quality for the first call according to its measured performance from the initial call from first mobile radio station 110.

Step 404 executes by establishing link 122 between first base station 102 and first mobile radio station 110. First base station 102 and first mobile radio station 110 may exchange data over signals using link 122. First mobile radio station 110 may transmit signals to first base station 102. If first mobile radio station 110 is not transmitting, then first base station 102 may transmit signals to first mobile radio station 110.

Step 408 executes by receiving a second call within HF cellular system 100. For example, second mobile radio station 112 may initiate call 118. Step 410 executes by determining the best base station to receive call 118. Similar to step 403, controller 101 of HF cellular system 100 determines which base station provides the best reception quality for call 118. These determinations may be based on the evaluations of the call received at the base stations from second mobile radio station 112.

Step 412 executes by determining whether the selected base station to receive call 118 is first base station 102. If no, then step 414 executes by assigning call 118 to a receiver at the selected base station. For example, third base station 106 may provide the best reception quality for calls from second mobile radio station 112 so it is selected. Call 118 is assigned to a transmitter and a receiver at third base station 106. Flowchart 400 proceeds to step 422, disclosed below.

If step 412 is yes, then first base station 102 is determined to be the best candidate to receive call 118. First base station 102, however, has an active link 122. This link will need to be handed off to another base station to keep active. Step 416 executes by determining whether first base station 102 is transmitting over link 122 to first mobile radio station 110. If first base station 102 is transmitting, then it should not be interrupted as the transmission may not be completed. If first base station 102 is receiving a signal from first mobile radio station 110, then it should not be transmitting.

If step 416 is yes, then step 418 executes by waiting for a pause in the transmission from first base station 102. Any operations regarding first base station 102 or link 122 may be deferred until the pause is reached. When the pause is reached then flowchart 400 proceeds to step 420.

If step 416 is no, then step 420 executes by handing off link 122 to another base station in HF cellular system 100. In this instance, second base station 104 may be selected based on its reception quality of sounding transmission 120B from second mobile radio station 112. The disclosed embodiments hand off link 122 to second base station 104.

Step 422 executes by establishing a link from first base station 102 to second mobile radio station 112 to accept call 118. Thus, the disclosed embodiments manage the allocation of calls in an optimal manner by assigning new calls to the base station having the best performance to handle the call. An active link may stay active but is handed off to another base station having an open receive channel. The feature of multiple receive channels helps in this regard as a base station having an active link may still receive sounding transmission and linking calls in a receive channel not committed to the active link.

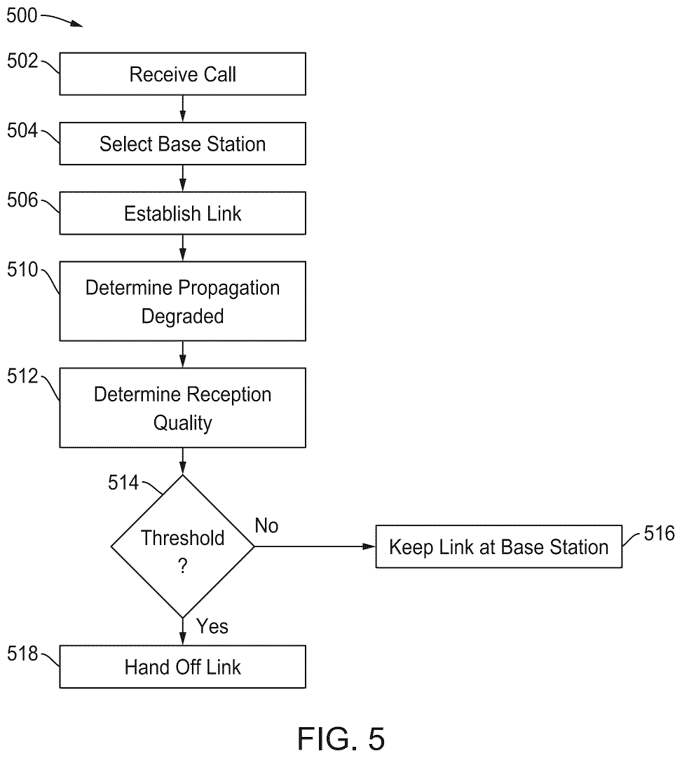

FIG. 5 depicts a flowchart 500 for handing off a call within HF cellular system 100 to due to degrading of the link between the base station and the mobile radio station according to the disclosed embodiments. Flowchart 500 may refer to FIGS. 1-4 for illustrative purposes. Flowchart 500, however, is not limited to the embodiments disclosed by FIGS. 1-4.

Step 502 executes by receiving a call from a mobile radio station within HF cellular system 100. Step 502 may be similar to step 402, disclosed above. Step 504 executes by selecting a base station to receive the call from the mobile radio station. Step 504 may be similar to step 403, disclosed above. Step 506 executes by establishing a link between the mobile radio station and the selected base station. Step 506 may be similar to step 404, disclosed above. For example, a link 122 may be established between base station 102 and receiver 206A of first mobile radio station 110.

Step 510 executes by determining that the propagation between first base station 102 and first mobile radio station 110 has degraded. Degradation of the reception quality may be determined by the transmissions and receptions on the link. Link 122 may degrade due to movement of the stations within system 100 or other factors to do with propagation of the signal. Conditions within HF cellular system 100 change during the day. These changes may cause degradation of the signals between the stations. Thus, it may be beneficial to change the base station assigned to the link.

Step 512 executes by determining a reception quality at base stations other than the station currently linked in HF cellular system 100, which may be done by having receivers at those stations monitor the ongoing link. Receivers other than receiver 206A that is actively supporting link 122 can monitor the reception quality of the channel, or frequency, that the link is using. Reception quality may be an estimate of the signal to noise ratio for that channel at the different receivers of the base stations. Historical data also may be considered from sounding transmissions. For example, system 100 may determine the reception quality at second base station 104 and third base station 106 using sounding transmissions 120A sent by first mobile radio station 110, such as before link 122 was established. Any decision, however, would mostly take into account the most current reception quality indications that would be determined by monitoring of the active link.

Step 514 executes by determining whether the reception quality at a respective base station meets a threshold that indicates it is better than the reception quality at first base station 102 for first mobile radio station 110. For example, the threshold may be a 50% better signal to noise ratio for a link at the respective base station than the current link. This threshold may be adjustable. In other words, some embodiments may want to be conservative in handing off links so it is not enough that another receiver has better reception quality but must have a specified improved level of reception quality. If step 514 is no, then step 516 executes by keeping link 122 at first base station 102. Flowchart 500 may return to step 514 to keep determining whether a better reception quality exists in the next base station.

If step 514 is yes, then the reception quality in that respective base station is above the threshold in comparison to the reception quality of first base station 102. Controller 101 determines that HF cellular system 100 would optimize performance by moving link 122 to that base station. For example, it may be determined that second base station 104 has better reception quality than first base station 102. Thus, step 518 executes by handing off link 122 to a receive channel at second base station 104. The transmitter and receiver currently supporting link 122 at first base station 102 are released, potentially to establish a link for a call in which it can provide better performance than the handed off link.

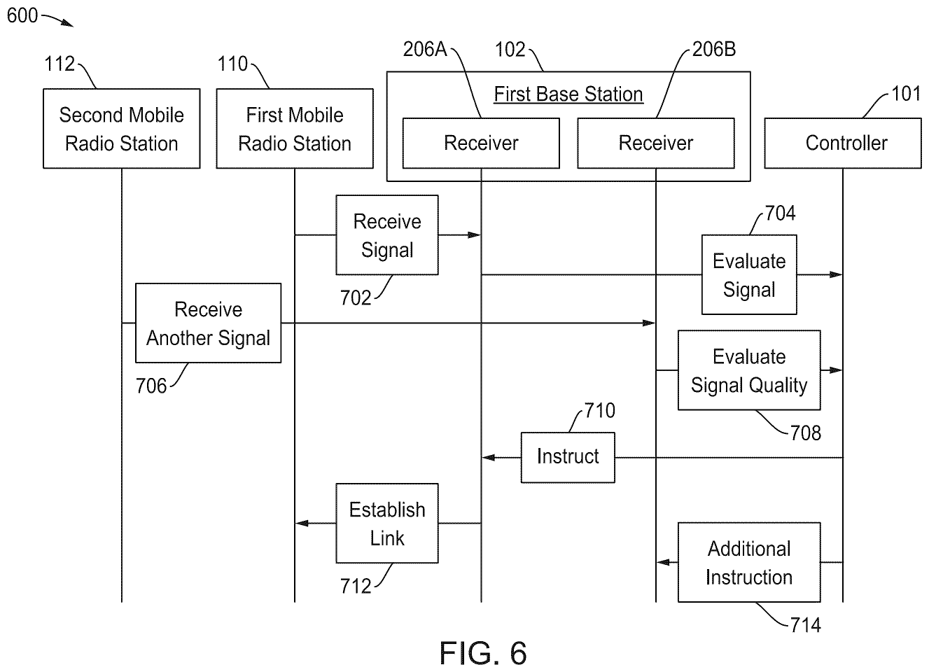

FIG. 6 depicts a flow diagram 600 for managing resources in HF cellular system 100 according to the disclosed embodiments. Flow diagram 600 may refer to FIGS. 1-5 for illustrative purposes. Flow diagram 600, however, is not limited to the embodiments disclosed by FIGS. 1-5.

Flow diagram 600 discloses operations between components within HF cellular system 100. These components may be first mobile radio station 110, second mobile radio station 112, first receiver 206A and second receiver 206B of first base station 102, and controller 101. Additional components and features disclosed above may be referenced in the operations disclosed herein, but not shown in FIG. 6.

An operation 702 executes by receiver 206A receiving a signal from first mobile radio station 110. The signal may be a linking call, a sounding transmission 120A, and the like. Receiver 206A may be scanning a frequency channel according to scan list 307 at first base station 102 and detects the signal within HF cellular system 100. Operation 704 executes by evaluating the signal received at receiver 206A by controller 101. Controller 101 is communicatively connected to first base station 102. Controller 101 may evaluate the performance quality of the signal. If it is a linking call, then the quality of receiver 206A in taking the call is determined. If the signal is a sounding transmission, then controller 101 may evaluate the quality of the sounding transmission as received. In some embodiments, operation 704 will cause receiver 206A to be occupied during the time to complete the evaluation.

Operation 706 executes by receiving another signal from HF cellular system 100 by receiver 206B also located at first base station 102. Receiver 206B would be a second receiver at first base station 102. While receiver 206A is occupied, receiver 206B may provide additional capacity within HF cellular system 100 to perform actions, such as receiving calls, sounding transmissions, monitoring links, scanning frequency channels, and the like. In this instance, the signal received in operation 706 needs to be evaluated. Thus, operation 708 executes by having controller 101 evaluate the performance quality of the signal received by receiver 206B.

At some point, operation 710 executes by instructing receiver 206A or first base station 102 to perform an action in response to the reception of the signal in operation 702. If the signal is a linking call, then controller 101 may determine that first base station 102 is best suited to receive the call and instructs first base station 102 to establish a link for the call using receiver 206A. Thus, operation 712 executes by establishing link 122 between transmitter 208A and receiver 206A and first mobile radio station 110. If the signal is a sounding transmission, such as sounding transmission 120A, then controller 101 may instruct first base station 102 to store the determined performance quality in an LQA table. In some embodiments, operation 710 may not be executed and receiver 206A released from doing any further operations.

Operation 714 also executes by instructing first base station 102 to perform an action related to the signal received at receiver 206B. Such an action may be making a link if receiver 206A is not in a link, handing off a link to another base station, as disclosed above, or deferring the hand off of the link. In some embodiments, operation 714 may be executed before operations 710 and 712 in that controller 101 is evaluating the signal received in operation 702 while operation 714 is executed.

In some embodiments, operations 706 and 708 are not executed. In other words, no signal is received at receiver 206B. In this instance, while receiver 206A is occupied with performing an action related to the signal received in operation 702, controller 101 may instruct first base station 102 to have receiver 206B scan the frequencies of scan list 307 or monitor a linked call using receiver 206A. In other words, receiver 206B may be utilized for additional actions by first base station 102 without having received a signal within HF cellular system.

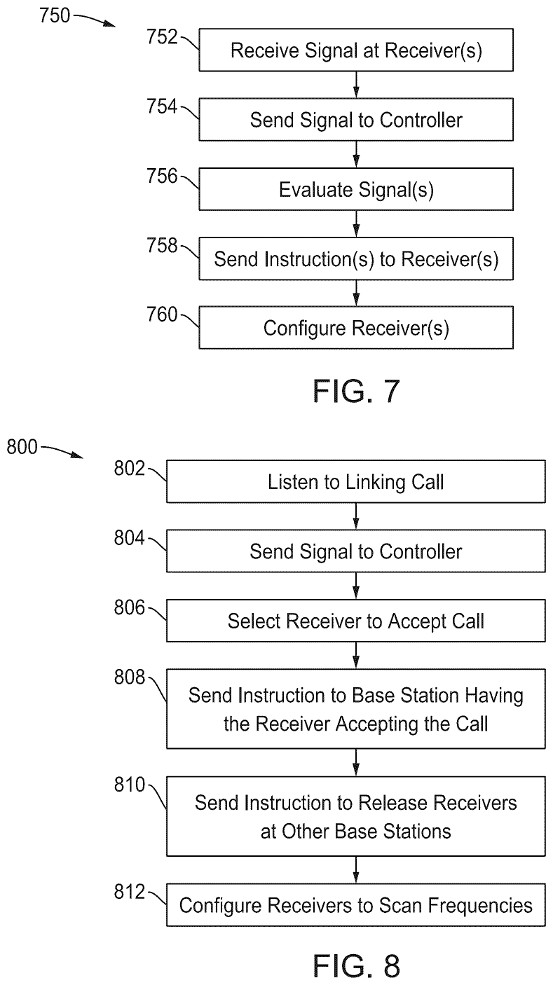

FIG. 7 depicts a flowchart 750 for further managing resources in HF cellular system 100 using controller 101 according to the disclosed embodiments. Flowchart 750 may refer to FIGS. 1-6 for illustrative purposes. Flowchart 750, however, is not limited to the embodiments disclosed by FIGS. 1-6.

Step 752 executes by receiving a signal, such as a linking call or a sounding transmission, at a receiver at each of the base stations in HF cellular system 100. Referring to FIG. 3, controller 101 may instruct a receiver at each base station to listen for signals emitted within the system. Thus, receiver 206A at first base station 102 and receiver 206C at second base station 104 may be configured to detect the signal. A receiver at third base station 106 also may be configured but not shown.

Step 754 executes by sending the received signal from the base stations to controller 101. Controller 101 is enabled to receive signals or information about the signals from the base stations. In some embodiments, the base stations send the signals as received by the receiver and controller 101 processes the signal for data. In other embodiments, the base stations may process the signal as received and then provide that data to controller 101.

Step 756 executes by evaluating the signal or signals received from the base stations by controller 101. Controller 101 may evaluate the signal strength or quality to determine what action to take. For example, if the signals relate to a linking call, then controller 101 may evaluate the strength of the different signals to determine which base station includes a receiver having the best performance in establishing a link along with the transmitter of the base station. If the signals relate to sounding transmissions, then controller 101 may evaluate the quality of each signal received at the respective receiver of the base station and store that for further operations.

Step 758 executes by sending one or more instructions to the base stations based on the evaluated signals from controller 101. Step 760 executes by configuring one or more receivers at the respective base stations in accordance with the one or more instructions from controller 101. For example, controller 101 may instruct transmitter 208A and receiver 206A of first base station 102 to establish a link for a call related to the linking call. It also may instruct receiver 206B to monitor other frequency channels or another action. It also may instruct receiver 206C of second base station 104 to monitor the link involving transmitter 208A and receiver 206A of first base station 102 to determine any change in performance.

Thus, controller 101 may receive signals or information about signals from all the base stations in system 100 and manage resources at the base stations to optimize the handling of calls, the capacity in the system, and what receivers are doing at each of the base stations.

FIG. 8 depicts a flowchart 800 for managing resources in HF cellular system 100 by controller 101 after receiving a linking call 118 according to the disclosed embodiments. Flowchart 800 may refer to FIGS. 1-7 for illustrative purposes. Flowchart 800, however, is not limited by the embodiments disclosed by FIGS. 1-7.

Step 802 executes by listening to a linking call with system 100 by a receiver at each base station. For example, second mobile radio station 112 may send a linking call 118 to all the base stations connected to controller 101. A receiver at each base station may receive linking call 118. As each base station is separated from second mobile radio station 112 by distance, this feature along with other factors, will influence the strength of linking call 118 received at the respective receivers at the base stations.

Step 804 executes by sending the received signal or information about the received signal to controller 101 communicatively coupled to the base stations. Controller 101 may evaluate the signals or their information to determine the strength of linking call 118 at the receivers at the different base stations. For example, linking call 118 may be received at receiver 206A of first base station 102 and receiver 206C at second base station 104. Controller 101 may evaluate the signal for linking call 118 received by receiver 206A and the signal for linking call 118 received by receiver 206C. The signals indicate which receiver is best configured to receive a call based on linking call 118.

Step 806 executes by selecting a receiver from the plurality of receivers providing the signal for linking call 118 by controller 101 to establish a link with second mobile radio station 112 based on the evaluation by controller 101. The link will be established with the selected receiver and a transmitter of the base station.

Step 808 executes by sending an instruction to the base station to configure the selected receiver to establish the call with second mobile radio station 112. For example, receiver 206A of first base station 102 may be determined to provide the best quality for a link with second mobile radio station 112 based on the strength of the signal received for linking call 118. Controller 101 sends an instruction to first base station 102 to configure receiver 206A to accept the call and establish a link along with transmitter 208A.

Step 810 executes by sending instructions to the other base stations in HF cellular system 100 having receivers that provided signals or information for linking call 118 to controller 101 and not selected. The instruction may instruct these base stations to release the receivers involved with receiving linking call 118. For example, controller 101 may send an instruction to second base station 104 to release receiver 206C and free it up for further operations.

Step 812 executes by configuring the receivers at the other base stations to scan frequencies in the scan list, as determined by controller 101. For example, the scan list may include five frequency channels of interest. Controller 101 may instruct a receiver at one base station to scan the first frequency, a receiver at another base station to scan a second frequency, and so on. This feature enables the scanning of the scan list without having all the base stations scan the same frequency at the same time. Thus, controller 101 may have the base stations not selected to establish the link perform actions to manage calls and transmissions in HF cellular system 100.

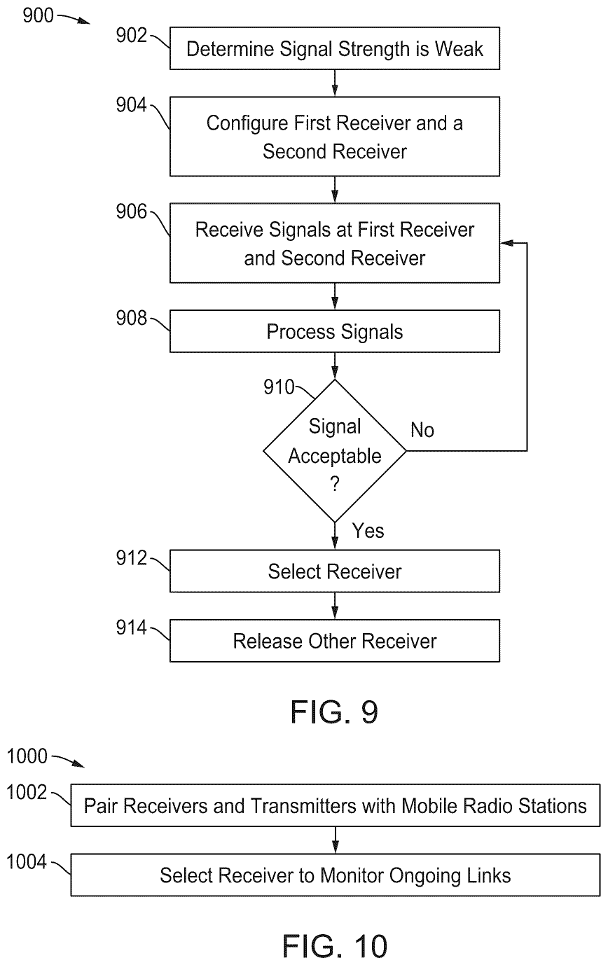

FIG. 9 depicts a flowchart 900 for managing resources between different base stations in HF system 100 by controller 101 according to the disclosed embodiments. Flowchart 900 may refer to FIGS. 1-8 for illustrative purposes. Flowchart 900, however, is not limited to the embodiments disclosed by FIGS. 1-8.

Step 902 executes by determining a signal received at more than one base station is weak. In other words, controller 101 evaluates the signals provided by receivers at the base stations and none of the signals are strong enough to support a link with the transmitting mobile radio station. In this instance, controller 101 may manage different receivers at different base stations to receive and process the respective received signal to establish the link along with one of the transmitters. Base station transmitters emits a stronger signal that mobile stations so the link should be of acceptable quality.

Step 904 executes by configuring, by controller 101, a first receiver located at one base station and a second receiver located at another base station to receive signals associated with the link. For example, controller 101 may send an instruction to first base station 102 to configure receiver 206A to receive signals associated with link 122 between first mobile radio station 110. It also may send an instruction to second base station 104 to configure receiver 206C to also receive signals associated with link 122 between first mobile radio station 110. Thus, controller 101 establishes link 122 between transmitter 208A of first base station 102 and receivers 206A and 206C.

Step 906 executes by receiving signals within link 122 from first mobile radio station 110 at receiver 206A at first base station 102 and receiver 206C at second base station 104. Any transmission to first mobile radio station 110 may occur using transmitter 208A. Step 908 executes by processing the received signals from the multiple receivers. The processing may occur at the respective base stations then the information regarding each signal provided to controller 101. Alternatively, each base station may provide its respective signal received to controller 101, which does the processing. Controller 101 may take the information provided in link 122 and perform further operations.

Step 910 executes by determining whether one of the signals received at one of the receivers is acceptable to have the entire linked call be handled at the station. In other words, the transmitter and the receiver can handle the link at an acceptable level. For example, if a base station provides a signal having an acceptable strength, or signal to noise ratio, then the link can be handled by that base station. Using this example, controller 101 may determine that receiver 206A at first base station 102 is receiving signals related to link 122 at a level that indicates that the first base station can take over the link along with transmitter 208A.

If step 910 is no, then flowchart 900 returns to step 906 to continue receiving signals at receivers 206A at first base station 102 and 206C at second base station 104. If step 910 is yes, then step 912 executes by controller 101 selecting the receiver receiving the signal at the acceptable level to pair with its transmitter to take over the link. Controller 101 may send an instruction to this effect. For example, controller 101 sends an instruction to first base station 102 that have receiver 206A and transmitter 208A continue supporting link 122. Step 914 executes by controller 101 releasing the other receiver from link 122. For example, controller 101 may send an instruction to second base station 104 to release receiver 206C from receiving signals from link 122.

It may be appreciated that controller 101 may configure receivers at base stations currently in link to support other links by receiving signals for links at other base stations. For example, second base station 104 may have receiver 206C and transmitter 208B supporting a link with a mobile base station. Controller 101 may configure receiver 206D of second base station 104 to support link 122 by also receiving signals from the link and providing those to controller 101 if the signal at receiver 206A is too weak. Thus, controller 101 may manage resources in system 100 to better optimize the handling of calls and resolving issues quickly.

FIG. 10 depicts a flowchart 1000 for managing resources in HF cellular system 100 to monitor links according to the disclosed embodiments. Flowchart 1000 may refer to FIGS. 1-9 for illustrative purposes. Flowchart 1000, however, is not limited to the embodiments disclosed by FIGS. 1-9.

Step 1002 executes by pairing a receiver and a transmitter at each base station with a mobile radio station within HF cellular system 100. Controller 101 may evaluate the different signals received at the receivers at the base stations and determine the best pairing to the mobile radio stations. For example, controller 101 may determine that receiver 206A at first base station 102 receives signals from first mobile radio station 110 better than any receiver at second base station 104 and any receiver at third base station 106. Thus, controller 101 pairs first base station 102 with first mobile radio station 110. This feature does not mean that all calls from first mobile radio station 110 will be accepted by first base station but that a receiver at first base station 102 may monitor signals from the first mobile radio station.

This same process may occur for second mobile radio station 112 and third mobile radio station 114. They may be paired with base stations within HF cellular system 100 by controller 101.

Step 1004 executes by selecting, by controller 101, a receiver at each base station to monitor ongoing links within HF cellular system 100. This receiver may be different from the receiver paired with a mobile radio station. Controller 101 may evaluate the strength of signals received at the paired base stations to determine when to switch the pairings to optimize the management of calls in system 100. For example, controller 101 may instruct a receiver at each station to receive sounding transmissions or scan frequencies to receive signals from other base stations while a transmitter and another receiver are in link with the paired mobile station. This feature allows controller 101 to manage resources and optimize the handling of calls, and determining when to switch pairings or hand-off links, as disclosed above.

While the present disclosure has been particularly described, in conjunction with specific preferred embodiments, it is evident that many alternatives, modifications and variations will be apparent to those skilled in the art in light of the foregoing description. It is therefore contemplated that the appended claims will embrace any such alternatives, modifications and variations as falling within the true scope and spirit of the present disclosure.

What is claimed is:

1. A method for managing resources in a high frequency (HF) cellular system, the method comprising:
receiving a first signal from a first mobile radio station at a first base station having a transmitter and a plurality of receivers in the HF cellular system;
performing an action related to the first signal using a first receiver of the plurality of receivers at the first base station;
receiving a second signal from the HF cellular system at a second receiver of the first base station while the first base station is performing the action related to the first signal; and
performing an action related to the second signal using the second receiver at the first base station while the first receiver is occupied with the first signal.

2. The method of claim 1, wherein the action related to the first signal includes evaluating the first signal.

3. The method of claim 2, wherein the first signal includes a linking call from the first mobile radio station, and
further comprising establishing a link between the transmitter and the first receiver of the first base station and the first mobile radio station based on the evaluated linking call.

4. The method of claim 3, wherein performing the action related to the second signal includes performing the action using the second receiver while the transmitter and the first receiver are engaged in the link.

5. The method of claim 3, wherein the second signal includes a linking call from a second mobile radio station in the HF cellular system, and further comprising
evaluating the linking call from the second mobile radio station;
determining, through the use of the second receiver at the first base station, that the first base station is best suited to accept the second linking call from the second mobile station.

6. The method of claim 5, further comprising handing off the link between the first transmitter and the first receiver and the first mobile radio station to a transmitter and a receiver at the second base station.

7. The method of claim 6, further comprising
determining that the first base station is currently transmitting over the link using the transmitter to the first mobile radio station; and
deferring the handing off of the link to the second base station until a pause is detected in the transmitting using the transmitter from the first base station.

8. The method of claim 7, further comprising
determining the link between the transmitter and the first receiver and the first mobile radio station is completed; and
initiating a callback for the linking call from the second mobile radio station using the second receiver of the first base station.

9. The method of claim 2, wherein the second signal received at the second receiver is a sounding transmission from a second mobile radio station, and further comprising evaluating the sounding transmission received at the second receiver.

10. The method of claim 1, wherein the action related to the first signal includes establishing a link for a call between the transmitter and the first receiver of the first base station and the first mobile radio station.

11. The method of claim 10, further comprising
determining the link between the first receiver and the first mobile radio station has degraded;
determining a reception quality of a receiver at a second base station by monitoring the link between the first receiver and the first mobile radio station with the receiver at the second base station;
determining the reception quality for the receiver at the second base station is above a threshold; and
handing off the link for the call from the first receiver at the first base station to the receiver and a transmitter at the second base station.

12. A method for managing resources in a high frequency (HF) cellular system, the method comprising:
enabling a controller to receive a signal or information about the signal from at least one base station of a plurality of base stations communicatively coupled to the controller, wherein each of the plurality of base stations includes a transmitter and a plurality of receivers;
evaluating the signal or the information about the signal from the at least one base station at the controller;
sending an instruction from the controller to the at least one base station of the plurality of base stations; and
configuring at least one receiver of the plurality of receivers at the at least one base station based on the evaluated signal or the information about the signal.

13. The method of claim 12, wherein the signal is a linking call, and further comprising
listening to the linking call using a receiver of the plurality of receivers at least two of the plurality of base stations; and
selecting a first receiver at a first base station of the plurality of base stations to accept the linking call based on the evaluated signal or the information about the signal,
wherein sending the instruction from the controller includes
sending an instruction to the first base station to accept the linking call, and
sending an instruction to release a receiver at the plurality of base stations not selected by the controller.

14. The method of claim 13, wherein the sending the instruction to release the receiver at the plurality of base stations not selected by the controller includes configuring the receiver at each of the plurality of base stations not selected by the controller to scan a frequency specified by the controller.

15. The method of claim 12, wherein the at least one receiver includes a plurality of receivers, the plurality of receivers having a first receiver at a first base station of the at least one base station and a second receiver at a second base station of the at least one base station, and
wherein configuring includes configuring at first receiver at the first base station and the second receiver at the second base station to receive the signal.

16. The method of claim 15, further comprising
monitoring the signal at the first receiver and the second receiver;
determining the signal is adequate at the first receiver; and
releasing the second receiver from receiving the signal.

17. The method of claim 15, further comprising
sending the signal from the first receiver and the second receiver to the controller and processing the signal received at the first receiver and the second receiver at the controller, or
processing the signal at the first receiver and the second receiver and sending the processed signal from the first receiver and the second receiver to the controller.

18. The method of claim 12, further comprising
selecting a receiver of at least one receiver at each of the at least one base station to monitor at least one link corresponding to the signal within the HF cellular system by the controller.

19. A high frequency (HF) cellular system comprising:
a plurality of base stations communicatively coupled to each other, wherein a first base station of the plurality of base stations includes a transmitter and a plurality of receivers; and
a plurality of mobile radio stations configured to transmit and receive signals within the HF cellular system,
wherein a first receiver of the plurality of receivers at the first base station receives a first signal from a first mobile radio station and the first base station performs a first action related to the first signal using the first receiver, and
wherein a second receiver of the plurality of receivers at the first base station receives a second signal from the HF cellular system while the first base station is performing the first action related to the first signal and the first base station performs a second action related to the second signal using the second receiver while the first receiver is occupied with the first signal.

20. The HF cellular system of claim 19, further comprising a second base station configured to receive an established link handed off from the first receiver of the first base station.
